(19) United States
(12) Patent Application Publication
(10) Pub. No.: US 2003/0212793 A1
(43) Pub. Date: Nov. 13, 2003

(54) Method and apparatus for group reception and fault-tolerant group transmission of frames in network

(76) Inventor: Vineet Kumar, Reston, VA (US)

Correspondence Address: VINEET KUMAR, 1821-204 SYCAMORE VALLEY DRIVE, RESTON, VA, 20190, US

(21) Appl. No.: 10/142,869

(22) Filed: May 13, 2002

(51) Int. Cl. G06F 15/173

(52) U.S. Cl. 709/226; 709/238

(57) ABSTRACT

Stations that periodically transmit and receive small amounts of data in the network, such as Ethernet, are grouped to collectively transmit and receive large amounts of data in the Ethernet frame thereby increasing the network bandwidth utilization. Groups of stations are formed by physically installing stations in such a way that the gap between frames transmitted by stations in a group is less than the Inter Frame Gap, which makes these frames look like a single frame to all stations in the network. The stations in a group collectively transmit a frame by counting the bytes already transmitted by other stations in a group, and by transmitting their part of data when the byte count reaches a predetermined count. Another group of stations in the network receive their part of data from a frame by counting the bytes in the frame and retrieving their part of the data from the frame when the byte count reaches a predetermined count. The group transmission is made fault tolerant so bursts of stations in the group fail but the group continues to operate properly.

### BACKGROUND OF THE INVENTION

This invention relates to computer networking, specifically to methods and systems efficiently transporting low bit-rate data on Ethernet.

The use of Ethernet as local area network (LAN) of choice in business and home is becoming widespread. Since Ethernet was developed decades ago for non real-time data applications that transfer large amount of data at a time, as compared to real-time data applications such as telephony voice that periodically transfer small amount of data at a time, it utilizes network bandwidth quite efficiently transporting large amount of data in a frame. Due to the popularity of Ethernet, other media such as telephony voice and video is being transported on Ethernet. Periodic generation of low bit rate data from various types of sensors—such as temperature sensors, movement detection sensors—is also being transported on Ethernet. Since Ethernet was not designed to periodically transport low bit rate data from applications such as telephony voice it utilizes network bandwidth quite efficiently. As an example, periodically transporting compressed (G 729) voice at a rate of 10 bytes every 10 ms in a frame with 26 bytes of overhead (preamble, destination and source address, type, and frame check sequence) makes inefficient use of network bandwidth. This problem is somewhat solved in Ethernet telephone stations available in the market today by packing large amount of voice in a frame for transportation on Ethernet. This solution introduces additional delay in a non real-time data network that already suffers from unpredictability in delay. This invention solves the problem of periodically transporting small amount of data on Ethernet by grouping stations so the group of stations collectively transmit and receive large amount of data in a frame. Also, a group of transmitter stations is made fault tolerant so the operation continues even when bursts of stations in the group fail.

### BRIEF SUMMARY OF THE INVENTION

The present invention provides methods and apparatus to utilize network bandwidth efficiently for stations that periodically transmit/receive small amount of data on the network. Even though the present invention applies to all shared networks, it is explained using IEEE 802.3 (CSMA/CD) shared Ethernet standard. This invention pertains to the physical (layer 1) and link (layer 2) layers of the OSI model.

One aspect of the present invention provides a method for forming groups of transmitter stations on the collision domain. The stations in the group collectively transmit large amount of data in a frame thereby utilizing the network bandwidth efficiently. The groups of transmitter stations are formed by physically installing stations in such a way that the round-trip propagation delay on the communication medium between neighbor stations is less than the predetermined maximum round-trip propagation delay. Then the gap between frames transmitted by stations in the group is less than the Inter Frame Gap, which makes these frames look like a single frame to all stations in the network.

Another aspect of the present invention provides a method for group transmission of a frame. The stations in the group transmit their data in a predetermined order. The head (first) station transmits the frame header and other data on the collision domain. The frame header has a unique destination multicast address which is used by the remaining stations in the group to identify the frame in which to transmit. The remaining stations count the bytes in the data on the collision domain to determine when to transmit their data. The frame ends when the tail (last) station in the group transmits its data followed by the Frame Check Sequence (FCS) on the collision domain.

Another aspect of the present invention provides a method so that group of receiver stations can receive their part of the data from a frame in the network. The frame is identified by the group of receiver stations through the unique destination multicast address in the frame header. The stations then count the bytes in the frame in the network to determine when to receive their data.

Still another aspect of the present invention provides a method to make groups of transmitter stations fault tolerant. The transmitter stations in the group can determine the first station in a burst of station failures that has failed in the group. By jamming the collision domain for a predetermined period of time the operating stations determine the first operating station after the burst of failed stations in the group. A new group is formed with the first operating station as the head station followed by the remaining stations in the same order as the previous group.

### BRIEF DESCRIPTION OF THE DRAWINGS

In the drawings, closely related figures have the same number but different alphabetic suffixes. Also, like elements have the same reference numeral designations across figures.

FIG. 1A illustrates one implementation of forming groups of transmitter stations on the collision domain. FIG. 1B conceptually represents FIG. 1A.

FIG. 2 is a block diagram of one implementation of a station.

FIG. 3 illustrates one implementation to test validity of groups of transmitter stations to collectively transmit a frame on collision domain.

FIGS. 4A, 4B, 4C illustrate one implementation of group transmission of frame on collision domain.

FIG. 5 illustrates one implementation of group reception of frame in network.

FIG. 6 illustrates one implementation of fault-tolerant group of transmitter stations on collision domain.

FIGS. 7A, 7B, 7C, 7D, 7E are a flowchart illustrating one implementation of operation of station for fault-tolerant group transmission of frame on collision domain.

FIG. 8 is a flowchart illustrating one implementation of operation of station for group reception of frame in network.

### DETAILED DESCRIPTION OF THE INVENTION

### Forming Groups of Transmitter Stations on Collision Domain

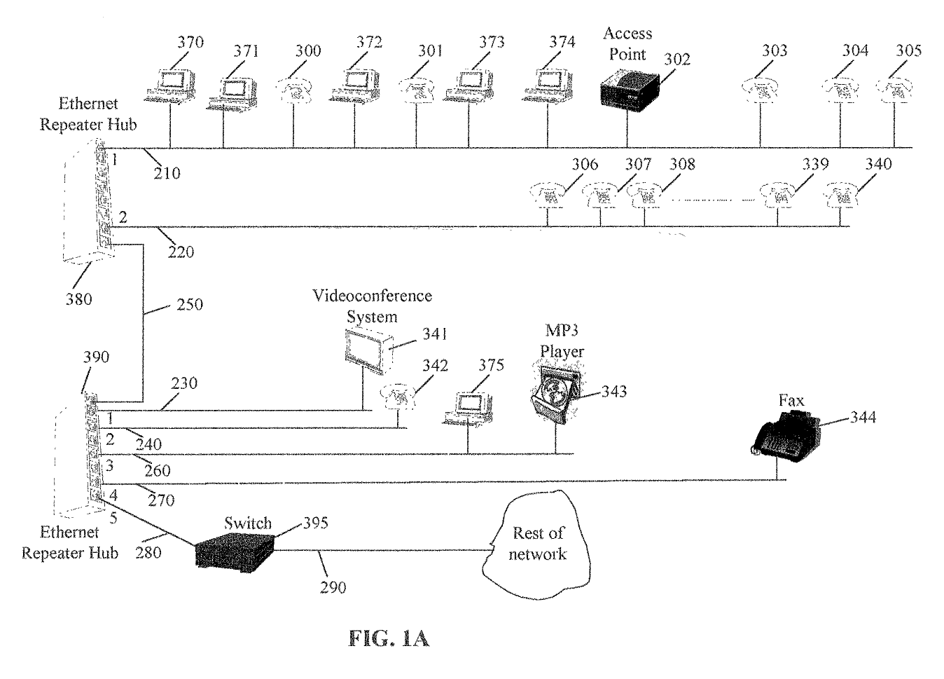

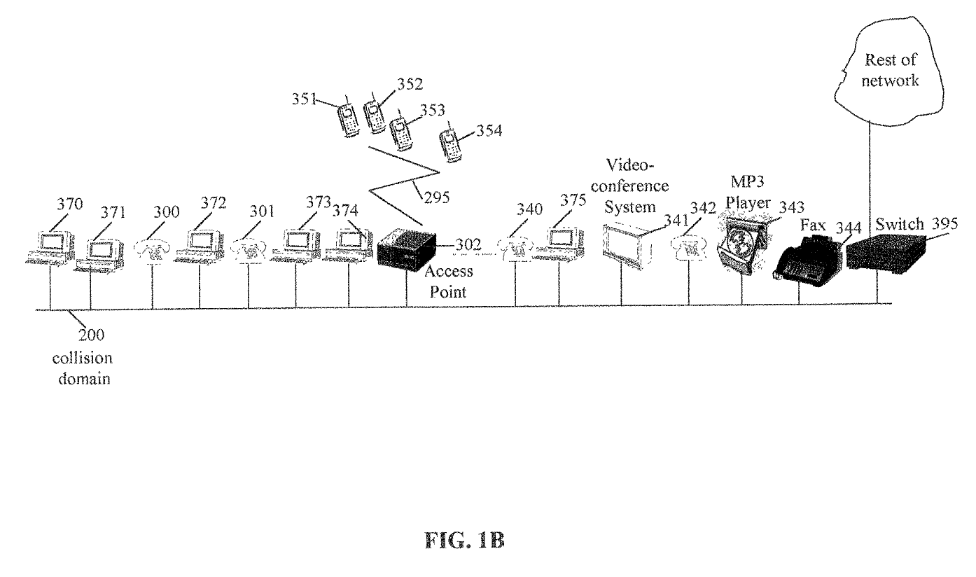

FIGS. 1A, 1B, 2, 3—One Implementation of Forming Groups of Transmitter Stations on Collision Domain

FIG. 1 illustrates one implementation of physical installation to form groups of transmitter stations on Ethernet collision domain. FIG. 1A illustrates the Ethernet collision domain formed by connecting Ethernet stations and Ethernet switch to Ethernet repeater hubs with a wired communication medium. The communication medium can be wired, wireless, or a combination of both. Stations include: telephones 300, 301, 303 through 340, and 342; access point 302; videoconferencing system 341; MP3 player 343; facsimile machine 344; and personal computers 370 through 375. Repeaters include: repeater 380 and 390. Switches include: switch 395. The switch connects this collision domain to the rest of the network.

The groups of transmitter stations are formed as follows: A transmitter station is in the same group as its neighbor transmitter station if the round-trip propagation delay on the communication medium between them is less than a predetermined maximum round-tip propagation delay. Mechanism to determine the maximum round-trip propagation delay is described later in this invention. The round-trip propagation delay is normally twice of one-way propagation delay.

The repeater 380 has two ports. Stations 300 through 305, 370 through 374 connect to port 1 of repeater 380 with a coaxial cable 210. The round-trip propagation delay on the communication medium between station 300 and its right neighbor station 301 is kept less than the predetermined maximum round-trip propagation delay. The round-trip propagation delay on the communication medium between stations 301, 302, 303, 304 and their respective right neighbor stations 302, 303, 304, 305 is kept less than the predetermined maximum round-trip propagation delay. Therefore, stations 300 through 305 are candidates for a single group. Stations 370 through 374 are not considered for grouping.

Stations 306 through 340 connect to port 2 of repeater 380 with a coaxial cable 220. The round-trip propagation delay on the communication medium between station 305 and its right neighbor station 306 is kept less than the predetermined maximum round-trip propagation delay. On this port 2 of repeater 380 the round-trip propagation delay on the communication medium between neighbor stations is kept less than the predetermined maximum round-trip propagation delay. Therefore, stations 300 through 340 are candidates for a single group. The repeater 380 connects to repeater 390 by a communication medium 250.

The repeater 390 has five ports. Station 341 connects to port 1 of repeater 390 with a coaxial cable 230. The round-trip propagation delay on the communication medium between station 340 and its right neighbor station 341 is greater than the predetermined maximum round-trip propagation delay, so stations 340 and 341 cannot be grouped. Therefore, stations 300 through 340 are candidates for a single group, and station 341 starts a new group. Station 342 connects to port 2 of repeater 390 with a coaxial cable 240. The round-trip propagation delay on the communication medium between station 341 and its right neighbor station 342 is less than the predetermined maximum round-trip propagation delay. Therefore, stations 341 and 342 are candidates for a new group.

Stations 375 and 343 connect to port 3 of repeater 390 with a coaxial cable 260. Station 375 is not considered for grouping. Station 343 does not transmit, so it is also not considered for grouping. Station 344 connects to port 4 of repeater 390 with a coaxial cable 270. The round-trip propagation delay on the communication medium between station 342 and its right neighbor station 344 is greater than the predetermined maximum round-trip propagation delay, so stations 342 and 344 cannot be grouped. Therefore, stations 300 through 340 are candidates for a group, stations 341 and 342 are candidates for another group, and station 344 is in a group by itself. A switch/router 395 connects to port 5 of repeater 390 with a coaxial cable 280, and to the rest of the network with a coaxial cable 290.

The collision domain is formed by the connection of repeaters 380 and 390 using cable 250; the connection of repeaters 380 and 390 with stations 300 through 344, 370 through 375, and switch 395 using cables 210, 220, 230, 240, 260, 270, 280. This collision domain can be conceptually arranged in the shape of a line and represented as collision domain 200 in FIG. 1B. The stations 300 through 344, 370 through 375, and switch/router 395 of FIG. 1A are also shown on collision domain 200 of FIG. 1B. Thus the entire physical installation of FIG. 1A is conceptually represented in FIG. 1B. Each station has at least one neighbor station. Even though station 300 has a right neighbor station 372, the station 372 is not considered for grouping so station 300 has station 301 as its right neighbor. The communication medium between station 300 and its right neighbor station 301 is kept less than the predetermined maximum round-trip propagation delay so these two stations can be grouped. So, the stations that were physically installed for grouping have a round-trip propagation delay on the communication medium with their neighbor stations that is less than the predetermined maximum round-trip propagation delay. In addition to stations of FIG. 1A, FIG. 1B shows additional stations—wireless telephones 351 through 354—forming a wireless collision domain 295 with access point 302.

It should be noted in this specification that a collision domain is root limited to a wired connection. It also includes wireless and a combination of both wired and wireless. It also includes any kind of shared communications channel. Also, the conceptual shape of the collision domain can be in any form (e.g. ring) as long as each station in the group of transmitter stations has at least one neighbor station.

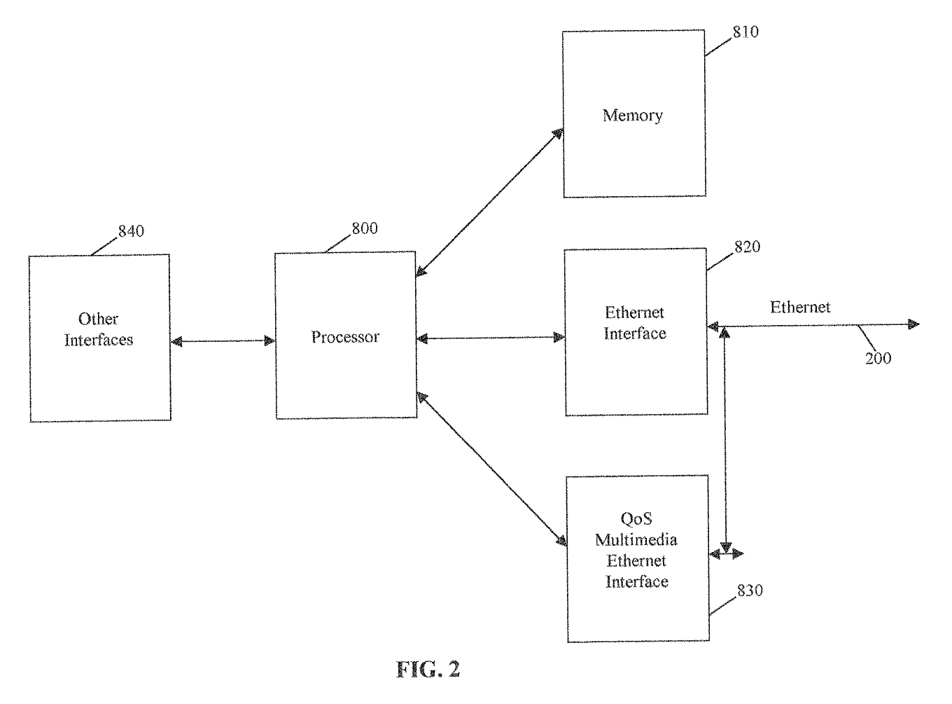

FIG. 2 is a block diagram of one implementation of a station. It includes a processor 800, memory 810, two Ethernet interfaces 820 and 830, and other interfaces 840 not pertinent to this invention. The processor 800 moves data between collision domain 200 and other interfaces 840. The Ethernet interface 820 executes the native CSMA/CD protocol. The QoS Multimedia Ethernet interface 830 executes the QoS Multimedia Protocol (QMP) of this invention. The QMP enables multiple stations to receive data from a single Ethernet frame, and it enables fault-tolerant group transmission of Ethernet frames on collision domain 200 QMP is a link layer (layer 2 of the OSI model) protocol of this invention that works alongside with the native link layer protocol (e.g. CSMA/CD). The features of QMP that include group reception and transmission of frame are described later in this invention. Even though the two Ethernet interfaces—820 and 830—are shown as two separate interfaces, they provide a single interface to collision domain 200.

A station is a candidate for grouping if it has the QoS Multimedia Ethernet interface 830, and the round-trip propagation delay on the communication medium between itself and its neighbor station is less than the predetermined maximum round-trip propagation delay. In FIG. 1B, the stations 370 through 375 are native Ethernet stations so they do not have the QoS Multimedia Ethernet interface 830 of FIG. 2. These stations will be referred to as native stations in the rest of this specification. The stations 300 through 344, 351 through 354 of FIG. 1B have the QoS Multimedia Ethernet interface 830 of FIG. 2. These stations will be referred to as QMP stations or just “stations ” in the rest of this specification. Based on the physical installation of FIG. 1A, in collision domain 200) stations 300 through 340 are candidates for a single group 300/340; stations 341 and 342 are candidates for another group 341/342, and station 344 is in a group 344 by itself. Stations transmit a frame at a time on the Ethernet. The minimum idle time between frames is the Inter Frame Gap (IFG). The QMP works on the principle that the frames transmitted by a group of stations have an idle time or gap less than IFG. Then native and QMP stations on Ethernet view these frames as a single frame. Since individual frames from a group of stations form a single Ethernet frame, these individual frames will be referred to as sub-frames in this specification. A station can transmit one or more sub-frames, and the size of the sub-frame is variable.

With this knowledge of the principle of QMP, the stations can be placed within a maximum round-trip propagation delay from each other (as shown in FIG. 1A) such that the frames they transmit are spaced less than the IFG. This theoretical maximum round-trip propagation delay is calculated as follows: On a 10 Mb/s Ethernet, signals travel about 2800 meters of coaxial cable and back in 512 bit times. The IFG is about 96 bit times. If we assume that it takes 24 bit times maximum for a station to transmit its sub-frame after it sees the end of a sub-frame from its neighbor station, then a maximum of 72 bit times are left for signals to travel from the station to neighbor station and back. This 72 bit times is the maximum round-trip propagation delay. This 72 bit times translate to a theoretical maximum length of about 393 meters of coaxial cable between two neighbor stations so that the gap between sub-frames is less than IFG. The number for the maximum round-trip propagation delay depends on the maximum time it takes for a station to transmit its sub-frame after it sees the end of a sub-frame from its neighbor station. In the example, 24 bit times is assumed as the time it takes a station to transmit its sub-frame. If it takes longer than 24 bit times then the maximum round-trip propagation delay and the maximum length of cable should be appropriately adjusted to lower than 72 bit times and 393 meters respectively. Conversely, if it takes shorter than 24 bit times then the maximum round-trip propagation delay and the maximum length of cable should be appropriately adjusted to higher than 72 bit times and 393 meters respectively.

Going back to FIG. 1A, the theoretical predetermined maximum round-trip propagation delay on communication medium consisting of coaxial cable between stations 300 and 301 is less than 72 bit times. Similarly, in group 300/340 the maximum round-trip propagation delay between a station and its neighbor station is less than 72 bit times. The same is true for group 341/342 where the maximum round-trip propagation delay between station 341 and its right neighbor 342 is less than 72 bit times.

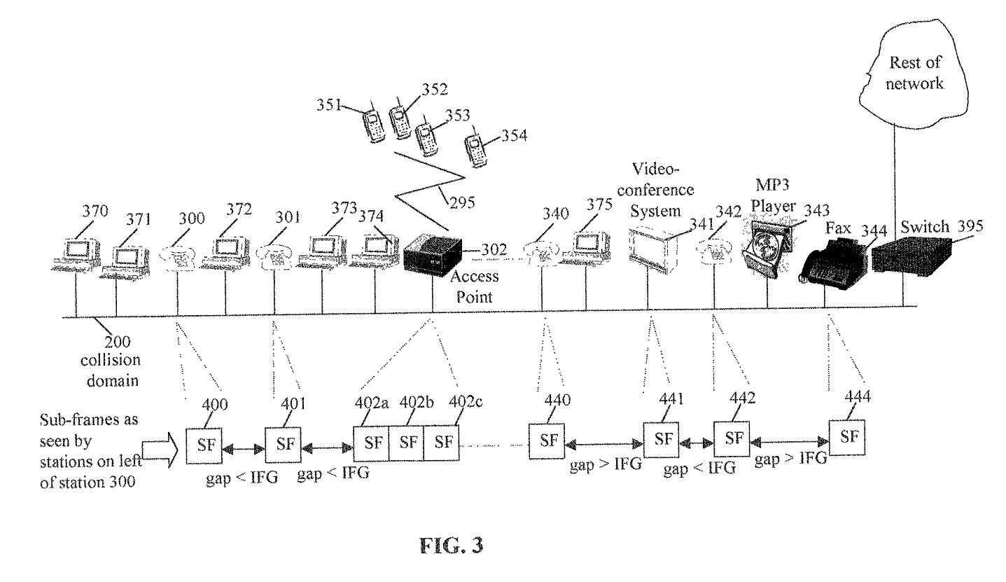

The validity of the groups formed so far can be tested with the setup of FIG. 3. FIG. 3 illustrates one implementation to test validity of groups of transmitter stations to collectively transmit a frame on collision domain 200. Each station transmits a sub-frame starting from the leftmost station 300 and moving one station at a time till the rightmost station 344. Each station (except the leftmost station 300) transmits its sub-frame within a predetermined maximum time of 24 bit times as soon as it sees the end of sub-frame from its left neighbor station. The station 300 is in the same group as its neighbor station 301 if the gap between sub-frame SF 400 from station 300 followed by sub-frame SF 401 from its neighbor station 301 is less than IFG.

In FIG. 3 the sub-frames SF 400 through SF 444 are shown as seen from the leftmost side of collision domain 200. Starting with station 300 and group 300, the gap between SF 400 and SF 401 is less than IFG so station 300 and station 301 are in the same group as group 300. Group 300 now expands to group 300/301. Moving on to the next station 301, the gap between SF 401 and SF 402a is less than IFG so station 301 and station 302 are in the same group as group 300/301. Group 300/301 now expands to group 300/302. Moving on to the next station 302, the gap between SF 402c and SF 403 is less than IFG so station 302 and station 303 are in the same group as group 300/302. Group 300/302 now expands to group 300/303. This process continues until we reach station 340 and group 300/340. Moving on to the next station 340, the gap between SF 440 and SF 441 is NOT less than IFG so station 340 and station 341 are NOT in the same group as group 300/340; a new group 341 is formed. Moving on to the next station 341 and group 341, the gap between SF 441 and SF 442 is less than IFG so station 341 and station 342 are in the same group as group 341. Group 341 now expands to group 341/342. Moving on to the next station 342. Its right neighbor station 343 is receive-only. Since station 343 does not transmit, station 342's right neighbor is station 344. The gap between SF 442 and SF 444 is NOT less than IFG, so station 342 and station 344 are NOT in the same group as group 341/342. So, a new group 344 is formed. Moving on, since station 344 does not have a neighbor to the right, this process of grouping stations into groups ends. From this process three group—group 300/340, group 341/342, and group 344—are formed in collision domain 200. These are the same groups that were formed previously from the physical installation of stations in FIG. 1A.

The description, so far, is of static groups. The group can change dynamically as stations are connected or removed from the network. In FIG. 3, if station 301 is removed from collision domain 200 and the gap between SF 400 and SF 402a is NOT less than IFG then station 300 and station 302 are NOT in the same group 300/340. Then group 300/340 is divided into two groups: station 300 is in its own group 300, and station 302 through station 340 form another group 302/340.

If the receive-only MP3 player of station 343 is replaced by a transmit/receive telephone, then group 341/342 and group 344 may change dynamically. If the gap between sub-frames from station 342 and station 343 is less than IFG then group 341/342 would grow to group 341/343. Also, if the gap between sub-frames from station 343 and station 344 is less than IFG then group 341/343 would grow to group 341/344.

If groups are formed based on only active stations then the groups will change dynamically as stations switch from inactive-to-active states and from active-to-inactive states. An example of inactive station is an on-hook telephone, and active station is an off-hook telephone. If only stations 310 through 320 are active, then the collision domain 200 has only one group 310/320. When station 341 becomes active, then the collision domain 200 has another group 341. When station 314 switches from active-to-inactive, group 310/320 is divided into two groups; stations 310 through 313 form a group 310/313, and stations 315 through 320 form another group 315/320.

After grouping the transmitter stations at the physical layer, the physical layer groups should be regrouped at the link layer so that the frames produced by the link layer groups conform to the predetermined subset of link layer specifications of the native protocol. This subset is determined based on the network configuration, and the applications operating on it. For voice applications the predetermined subset does not include the use of Frame Check Sequence (FCS) field in the Ethernet frame because a greater error rate can be tolerated in real-time voice traffic in comparison with non real-time data traffic The predetermined subset of Ethernet link layer specifications includes the size of the Ethernet frame on the collision domain 200 to be within 72 bytes (26 bytes of header and FCS and 46 bytes of payload) and 1526 bytes (26 bytes of header and FCS and 1500 bytes of payload). To satisfy this constraint, consider the transmission rate of a telephone station transmitting 80 bytes of G.711 voice every 10 ms on collision domain 200. An Ethernet frame every 10 ms from the group 300/340 would exceed the upper limit of 1500 bytes of payload. Therefore, group 300/340 is divided into group 300/312 (note that station 302 transmits three sub-frames), group 313/326, and group 327/340. Each group transmits a frame every 10 ms on collision domain 200. This frame is within the size constraints of minimum of 72 bytes and maximum of 1526 bytes.

After grouping the stations at the physical and link layers, there may be other criteria that the grouping should satisfy. Due to failures of stations in the group, the group could be restricted to a maximum size of nine stations regardless of the number of sub-frames transmitted by the stations. Then there are two ways of grouping—one from link layer groups and the second directly from physical layer groups. In the first way, link layer group 300/312 is divided into group 300/308 and group 309/312; link layer group 313/326 is divided into group 313/321, and group 321/326; and link layer group 327/340 is divided into group 327/335, and group 335/340. In the second way, physical layer group 300/340 is divided into group 300/308, group 309/317, group 318/326, group 327/335, and group 313/340; this grouping also satisfies the link layer requirements of the minimum and maximum frame size.

### Group Transmission on Collision Domain

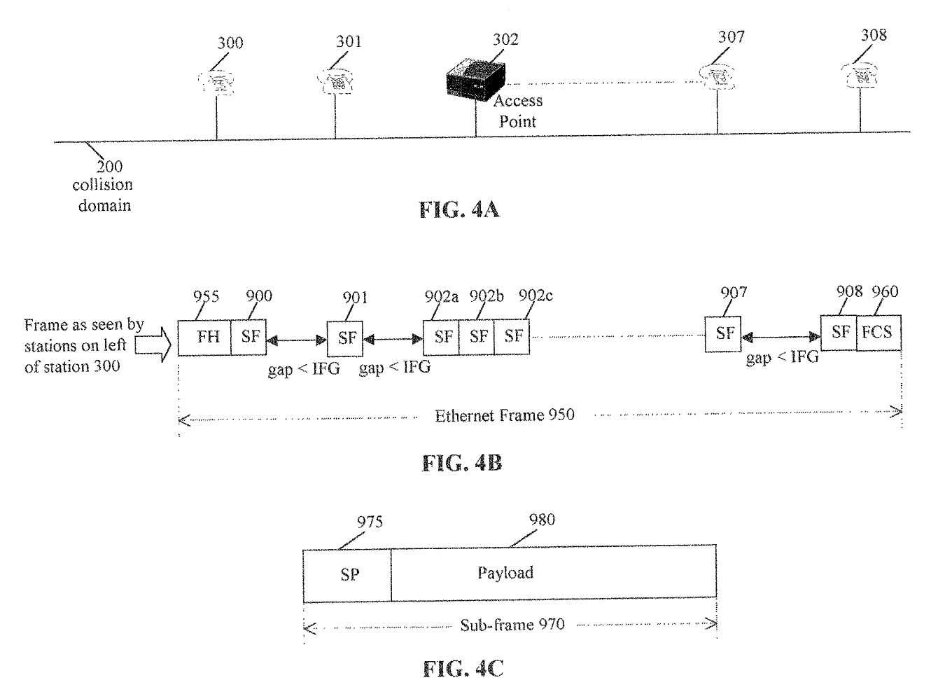

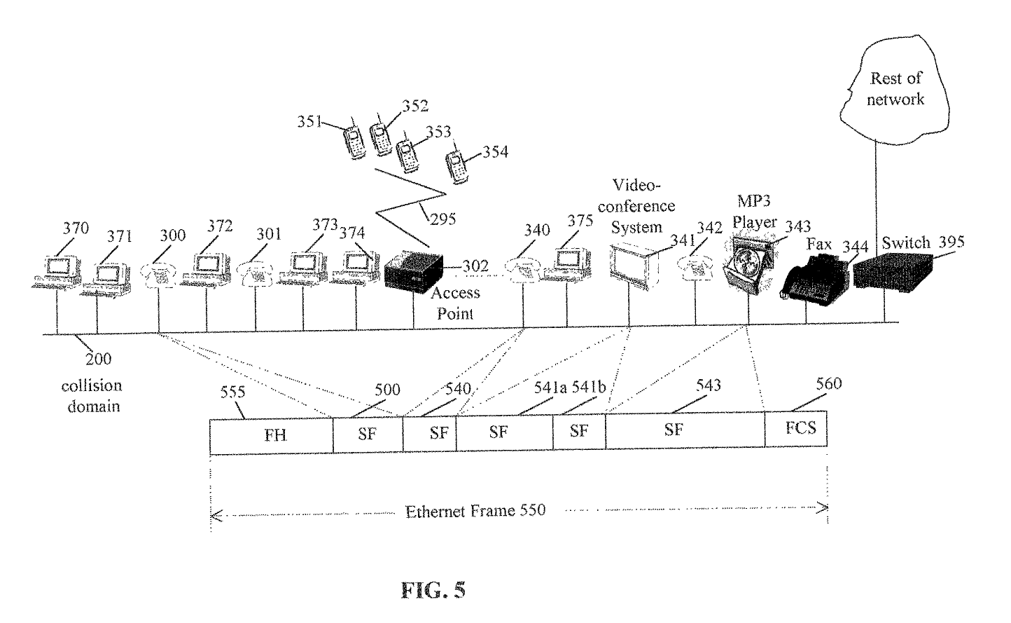

FIGS. 4A, 4B, 4C—One Implementation of Group Transmission of Ethernet Frame on Collision Domain

One implementation of forming groups of transmitter stations is described earlier. Once a group of transmitter stations is formed, one implementation of the group of transmitter stations to collectively transmit a frame is described here FIG. 4A shows the group 300/308 in the collision domain 200. The order of transmission of stations in the group 300/308 is first determined. Ordering is based on increasing or equal propagation delay in the same direction from the first station (head station) in the group. The head station is station 300. The remaining stations 301 through 308 are in the direction to the right of station 300 as signals from station 300 move to the right (as opposed to the left). The next station in order is station 301 because it has the minimum propagation delay from station 300 as compared with other stations 302 through 308. The next station in order is station 302 because it has the minimum propagation delay from station 300 as compared with other stations 303 through 308. In this way the order of transmission for group 300/308 starts with station 300 (head station), followed by stations 301, 302, 303, 304, 305, 306, 307 and ends with station 308 (tail station). The station 301 is at a distance of 1 from station 300. Similarly stations 302, 303, 304, 305, 306, 307 are at a distance of 2, 4, 3, 5, 6, 7 respectively from station 300. The group 303/308 collectively transmits a frame at a time.

FIG. 4B shows the transmission of the Ethernet frame 950 by stations 300 through 308 in group 300/308. Each station, except for station 302, transmits one 10-byte sub-frame. Station 302 transmits three 10-byte sub-frames. Each station in the group 300/308 is programmed with a unique destination multicast address and a unique byte offset. The unique destination multicast address is not only used to route the frame to its proper destination but also for stations 301 thorough 308 to identify the frame in which to transmit. This destination multicast address must only be used in frames transmitted by stations 300 through 308 in collision domain 200. The programmed byte offsets of stations in group 300/308 are: station 300 is 0 (it transmits bytes 1 through 10), station 301 is 10 (it transmits bytes 11 through 20), station 302 is 20 (it transmits bytes 21 through 50), station 303 is 50 (it transmits bytes 51 through 60), and so on, ending with tail station 308 with 100 (it transmits bytes 101 through 110).

The head station 300 starts frame 950 by transmitting the Ethernet Frame Header (FH) 955 consisting of the programmed destination multicast address followed by a 10-byte sub-frame SF 900 on collision domain 200. The station 301 sees start of frame 950 with FH 955 on collision domain 200. It identifies frame 950 by comparing the destination multicast address in FH 955 with its programmed destination multicast address. If there is a match it starts counting the bytes after the end of FH 955. Note that non-data symbols, and sub-preamble (explained later) are not counted. After it has counted the 10 bytes in SF 900, the byte count equals its programmed byte offset of 10. It then transmits its 10-byte sub-frame SF 901 within a predetermined maximum time (e.g. 24 bit times) from SF 900 on collision domain 200. The station 302 sees start of frame 950 with FH 955 on collision domain 200. It identifies frame 950 by comparing the destination multicast address in FH 955 with its programmed destination multicast address. If there is a match it starts counting the bytes after the end of FH 955. After it has counted the 20 bytes in SF 900 and SF 901, the byte count equals its programmed byte offset of 20. It then transmits three 10-byte sub-frames SF 902a, SF 902b, and SF 902c on collision 200. The gap between sub-frames is less than IFG. The station 302 does not collect all the sub-frames SF 902a, SF 902b, and SF 902c before transmission on collision domain 200. This would introduce delay in SF 902a and SF 902b. Instead, it transmits sub-frames as they become available just in time for transmission.

This process—frame identification by comparing the destination multicast address in FH 955 with the programmed destination multicast address, if there is a match then counting bytes after the end of FH 955, and transmitting its sub-frames within a predetermined maximum time from previous sub-frame when the byte count equals the programmed byte offset—continues with each station in group 300/308 until the tail station 308. The station 308 sees FH 955 on collision domain 200. It identifies frame 950 by comparing the destination multicast address in FH 955 with the programmed destination multicast address. If there is a match it starts counting the bytes after the end of FH 955. After it has counted the 100 bytes ending in SF 907, the byte count equals its programmed byte offset of 100. It then transmits its 10-byte sub-frame SF 908 within a predetermined maximum time from SF 907 followed by FCS 960 on collision domain 200. For voice applications the FCS field in the Ethernet frame can be ignored because a greater error rate can be tolerated in real-time voice traffic in comparison with non real-time data traffic.

FIG. 4C shows the format of a sub-frame 970. It consists of two fields. The first field is the sub-preamble 975, which is used when one station stops transmitting and another station in the same group starts transmitting its sub-frames. The sub-preamble 975 is similar in functionality to the Preamble of an Ethernet frame. For 10 Mb/s Ethernet interfaces the sub-preamble enables receivers to synchronize themselves with the incoming data. If synchronization is not needed, then sub-preamble can be ignored or removed. The second field consists of payload 980. There is no restriction on the size of payload in the sub-frame as long as the sub-frame 970 fits in an Ethernet frame. Stations in a group can transmit multiple sub-frames of different sizes.

There are many other ways the order of transmission, frame identification, and data counting can be implemented. Instead of ordering Stations 300 through 308 on the basis of increasing or equal propagation delay in the same direction from the head station, other means for order of transmission of stations can be used. The transmitter stations in a group can be ordered in any other way as long as the round-trip propagation delay on the communication medium between neighbor stations is less than a predetermined maximum round-trip propagation delay. The stations can simply be ordered on the basis of the way they were physically installed.

Instead of using the unique destination multicast address for stations 301 (note that Station 0 starts the frame) through 308 to identify the frame 950 in which to transmit, other frame identification means can be used. In one scenario, a unique source address can be assigned to Stations 300 through 308 in the group. Then this unique source address in FH 955 of frame 950 identifies this frame 950. In another scenario, if the only frame generated on a collision domain is from Stations 300 through 308 then by simply identifying the start of a frame, the frame in which to transmit is identified. Stations 300 through 308 can count data from the start of frame instead of from the end of FH.

Besides counting data in units of bytes in network and comparing with byte offset to determine when to start transmission of sub-frames, data can be counted in other units of information such as bits, words, sub-frames. If offset is counted in units of sub-frames then a station counts the number of sub-frames after the end of FH. For 10 Mb/s Ethernet interfaces the end of sub-frame is marked by a gap. For 100 Mb/s and higher speed version of Ethernet interfaces, unused non-data symbols can be standardized and used to mark the start and end of a sub-frame. The station transmits its sub-frames when this sub-frame count equals the programmed sub-frame offset. If the offset is counted in units of bytes then the station counts the number of bytes after the end of FH. Non-data symbols and bytes in the sub-preamble are not counted in the byte count. The station transmits its sub-frames when this byte count equals the programmed byte offset.

### Group Reception in Network

FIG. 5—One Implementation of Group Reception of Ethernet Frame in Network

One implementation of a group of receiver stations to collectively receive a frame is described here. FIG. 5 shows the receptions of sub-frames from Ethernet frame 550 by a group of receiver stations 300, 340, 341, 343. The group of receiver stations is not derived from the groups that were formed from the physical installation, and the groups of stations that transmit.

The frame 550 consists of FH 555, followed by 10-byte sub-frame 500 for station 300, 10-byte sub-frame SF 540 for station 340, 30-byte sub-frame SF 541a and 10-byte sub-frame SF 541b for station 341, and 80-byte sub-frame SF 543 for station 343. Each station in the group is programmed with a unique destination multicast address and byte offsets. The programmed byte offsets of stations in the group are: station 300 is 0 (it receives bytes 1 through 10), station 340 is 10 (it receives bytes 11 through 20), station 341 is 20 (it receives bytes 21 through 60), and station 343 is 60 (it receives bytes 61 through 140).

As the frame 550 travels on collision domain 200, each station identifies frame 550 by comparing the destination multicast address in FH 555 with the programmed destination multicast address. If there is a match the station starts counting the bytes after the end of FH 555. Note that non-data symbols, and sub-preamble are not counted. After station 300 has counted 0 bytes, the byte count equals its programmed byte offset of 0. Station 300 then retrieves the 10 bytes in SF 500. After station 340 has counted 10 bytes, the byte count equals its programmed byte offset of 10. Station 340 then retrieves the 10 bytes in SF 540. After station 341 has counted 20 bytes, the byte count equals its programmed byte offset of 20. Station 341 then retrieves the 30 bytes in SF 541a and 10 bytes in SF 541b. After station 343 has counted 60 bytes, the byte count equals its programmed byte offset of 60. Station 343 then retrieves the 80 bytes in SF 543. At the end of the end of the frame 550, each station in the group retrieves the FCS 560 and compares it with the FCS that is calculated on its own. If there is a match, the sub-frames retrieved are valid. For voice applications the FCS field in the Ethernet frame can be ignored because a greater error rate can be tolerated in real-time voice traffic in comparison with non real-time data traffic.

The group of receiver stations changes dynamically as stations switch from inactive-to-active states and from active-to-inactive states. When telephones are off-hook they are in an active state receiving data from the network. When telephones are on-hook they are in an active state and are not receiving data from the network. If group of receiver stations include stations 300, 340, 341, 343 and station 340 goes off-hook then the group of receiver stations dynamically changes to include stations 300, 341, 343. If stations 342 and 344 go on-hook then the group of receiver stations dynamically changes to include stations 300, 341, 342, 343, 344.

The alternate implementations of frame identification and data counting described in the previous section for a group of transmitter stations also apply to the group of receiver stations.

### Fault-Tolerant Groups of Transmitter Stations on Collision Domain

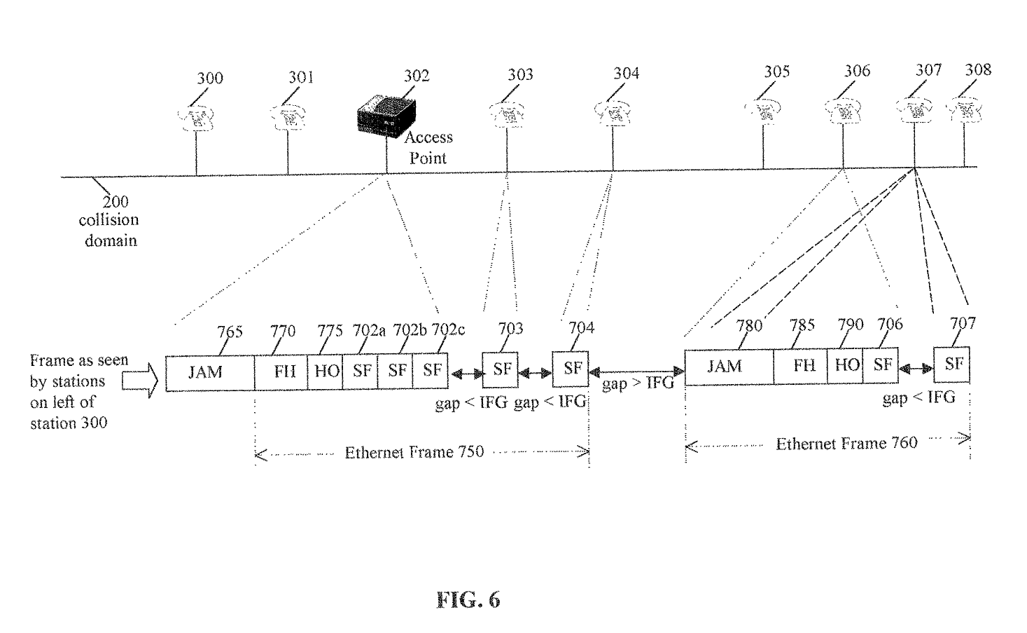

FIG. 6—One implementation of Fault-Tolerant Group of Transmitter Stations on Collision Domain

The group of transmitter stations described so far will stop working if a station in the group fails or is removed from the collision domain. This section describes one implementation of how a group recovers after bursts of stations in the group fail. The level of recovery depends on the bursts of station failures that the group is configured to recover from. A group that is configured to recover from a burst of up to “n” (where “n” is a positive integer, n=1,2,3, . . . ) failures will continue to operate properly as long as bursts of up to “n” stations fail at a time. The recovery from failures involves determining the operational station that is next in order of transmission (i.e. closest in distance) from the station detected to have failed, so that transmission on the collision domain can continue from this operational station. The fault-tolerant group works in such a way (explained later) that the operational stations detect the first failed station in a burst of “n” station failures. This recovery is accomplished by involving the participation of stations that are at a distance of up to “n” stations from the station detected to have failed. If the stations in the group are ordered based on increasing propagation delay from the head station then the participating stations jam the collision domain for a time period equivalent to:

jamTime=(propagation delay between this station and station with maximum distance)+(slot time)+(k*(n−distance))

Since station with the minimum distance from failed station starts jamming first and the station with the maximum distance from failed station starts jamming last, the jam time contributed by the first item in the equation is such that all participating stations go to the second item in the equation at approximately the same time. The slot time of 10 Mb/s and 100 Mb/s Ethernet is 512 bits (excluding Preamble). The jam time contributed by the second item—slot time—in the equation guarantees that all native and QMP stations (except participating stations with a distance less than the maximum distance) in the collision domain will stop transmission well before the end of this jam time. The participating stations end the jam, contributed by the first two items in the equation, at approximately the same time. The third item of the equation determines the station that will jam for the longest time. It consists of a constant “k” multiplied by a number that is inversely proportional to the distance of this station from the station detected to have failed. The value of “k” is chosen in such a way that the stations with less distance from the failed stations are guaranteed to have longer jam periods than stations with more distance from the failed stations. Therefore, the operational station that is closest in distance to the failed station has the longest jam period, and the station with the maximum distance has the shortest jam period. The station will know that it is the closest when it will not detect collisions towards the end of its jam period. The participating station with the maximum distance does not jam during the period contributed by the third item.

If the transmitter stations in a group are not ordered based on increasing propagation delay from the head station, then the first item in the jamTime equation is ignored. Here again, the value of “k” is chosen in such a way that the stations with less distance from the failed stations are guaranteed to have longer jam periods than stations with more distance from the failed stations.

FIG. 6 illustrates one implementation of fault-tolerant (fail-safe) group of transmitter stations on collision domain. If group 300/308 is said to be fault-tolerant (recover) from a burst of single station failure then stations 300, 302, 304, 306, 308 can simultaneously fail but the remaining stations 301, 303, 305, 307 will continue to function. The operational station at a distance of 1 (for single burst of failures) station from failed station is used to recover from the failure. In this case station 301 is at a distance of 1 from the failed station 300, station 303 is at a distance of 1 from the failed station 302, and so on. There is no need to jam the collision domain to determine the closest operational station because there is only one participating station.

If group 300/308 is said to recover from a burst of up to two station failures then stations 300, 301, 303, 304, 306, 307 can simultaneously fail but the remaining stations 302, 305, 308 will continue to function. The stations at a distance of up to 2 (for burst of 2 failures) stations from the station detected to have failed are used to recover from the failure. If stations 300 and 301 fail, stations 301 and 302 are at a distance of up to 2 stations from station 300 detected to have failed. Station 301 would have jammed the collision domain for a time period equivalent to (propagation delay between stations 301 and 302+slot time+k) if it were operational, whereas station 302 will jam for a time period equivalent to (slot time). If stations 303 and 304 fail, stations 304, and 305 are at a distance of up to 2 stations from station 303 detected to have failed. Station 304 would have jammed the collision domain for a time period equivalent to (propagation delay between stations 304 and 305+slot time+k) if it were operational, whereas station 305 will jam for a time period equivalent to (slot time).

If group 300/308 is said to recover from a burst of up to three station failures then stations 300, 301, 302, 304, 305, 306 can simultaneously fail but the remaining stations 303, 307, 308 will continue to function. The stations at a distance of up to 3 (for burst of 3 failures) stations from the station detected to have failed are used to recover from the failure. If stations 300, 301, 302 fail, stations 301, 302, 303 are at a distance of up to 3 stations from station 300 detected to have failed. Station 301 would have jammed the collision domain for a time period equivalent to (propagation delay between stations 301 and 303+slot time+2k) if it were operational. Station 302 would have jammed the collision domain for a time period equivalent to (propagation delay between stations 302 and 303+slot time+k) if it were operational. And station 303 will jam for a time period equivalent to (slot time).

In order to make groups of transmitter stations fault tolerant, a new field “head_offset” is added to the frame on the collision domain. As shown in FIG. 6, this field occurs right after FH 770, and before the sub-frame SF 702a starts. It provides the offset of the head station in bytes (or any other unit of information that can be counted by a station). The byte count of a station starts with the number provided by head_offset. The stations count data from end of “head_offset” (instead of FH as mentioned in previous sections) field to determine when to start transmission/reception of their sub-frames.

One implementation of fault-tolerant group of transmitter stations is illustrated in FIG. 6. It shows group 300/308 on collision domain 200. Each station in the group 300/308 is programmed with a unique destination multicast address, a byte offset, and some mechanism through which the station knows when to start the frame (Frame-Start-Time). The offset of station 300 is 0 (it transmits bytes 1 through 10), station 301 is 10 (it transmits bytes 11 through 20), station 302 is 20 (it transmits bytes 21 through 50), station 303 is 50 (it transmits bytes 51 through 60), and so on, ending with tail station 308 with an offset of 100 (it transmits bytes 100 through 110). Assume that stations 300, 301, 305, and 308 fail simultaneously, and the fault-tolerant group 300/308 is configured to recover from a burst of up to 2 station failures.

Since the head station 300 has failed it does not start the frame. When the Frame-Start-Time of stations in the group 300/308 expires, the operational stations wait till any current frame ends plus some delay. Both stations 301, 302 are at a distance of up to 2 stations from station 300 detected to have failed, so both participate in determining the new head station. But station 302 is the only one operational, and it jams 765 the collision domain 200 for a time period equivalent to (slot time). It does not detect collisions during the end of slot time, so it transmits FH 770, its offset of 20 in head_offset 775, and 3 10-byte sub-frames SF 702a, SF 702b, SF 702c on the collision domain. The station 303 sees FH 770 on the collision domain. It compares the destination multicast address in FH 770 with the programmed destination multicast address. If there is a match it picks 20 from head_offset 775; it then start counting bytes after the end of head_offset 775. The byte count starts with the head offset of 20; the first byte after head_offset 775 is counted as 21. After it has counted the 3 10-byte sub-frames, the byte count of 50 equals its byte offset; it transmits its 10-byte sub-frame SF 703 on the collision domain. This process continues with station 304 transmitting 10-byte sub-frame SF 704. Station 305 has failed, so it does not transmit, and the frame reaches station 306.

The station 306 measures gap>IFG after SF 704. A byte count of 70 implies that station 305 at a distance of 1 has failed. It jams 780 the collision domain 200 for a time period equivalent to (slot time+propagation delay between station 306 and station 307+slot time+k. After reaching station 306, after a propagation delay between station 306 and station 307, the frame reaches station 307. The station 307 measures a gap>IFG after SF 704. A byte count of 70 implies that station 305 at a distance of 2 has failed. It jams 780 the collision domain 200 for a time period equivalent to (slot time). The station 306 continues to jam the collision domain for a time period equivalent to “k” after station 307 stops the jam station 306 does not detect collision for a time period equivalent to “k”, so it becomes the new head station. The station 306 then transmits FH 785, an offset of 80 in head_offset 790, and a 10-byte sub-frame SF 706. The station 307 sees FH 785 on the collision domain. The destination multicast address in FH 785 matches the programmed destination multicast address. It then picks 80 from head_offset 790; it starts counting the bytes after the end of head_offset field. After it has counted the 10-byte sub-frames, the byte count of 90 equals its byte offset; it transmits its 10-byte sub-frame SF 707 on the collision domain. Station 308 has failed, so transmission from this group 300/308 for this time period ends.

As a result of failure of stations 300, 301, 305, 308 in group 300/308 the operational stations 302, 303, 304 transmit the Ethernet frame 750 and the operational stations 306, 307 transmit the Ethernet frame 760. Both frames 750, 760 do not have the FCS field. The group 300/308 is regrouped into group 302/304 and group 306/307.

### Fault-Tolerant Group Transmission and Reception of Frame in Network

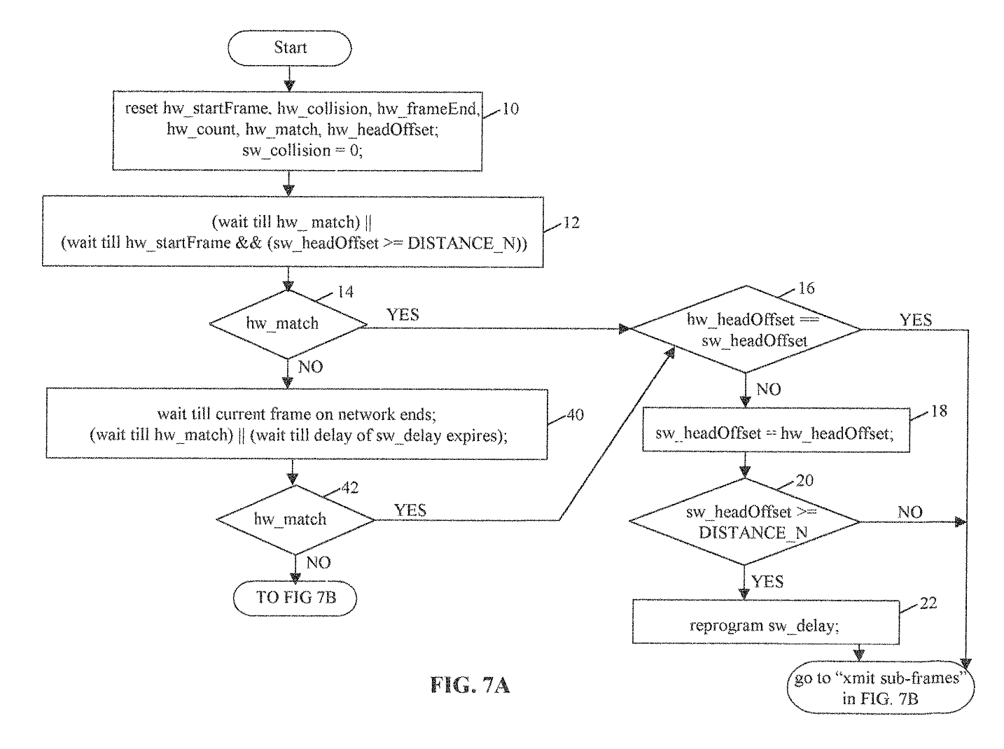

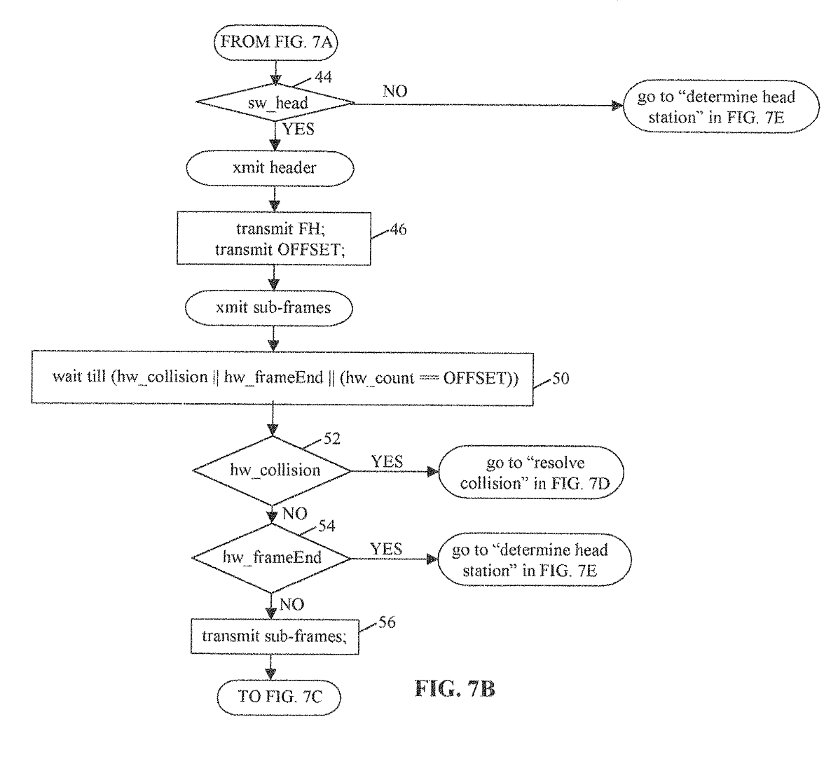

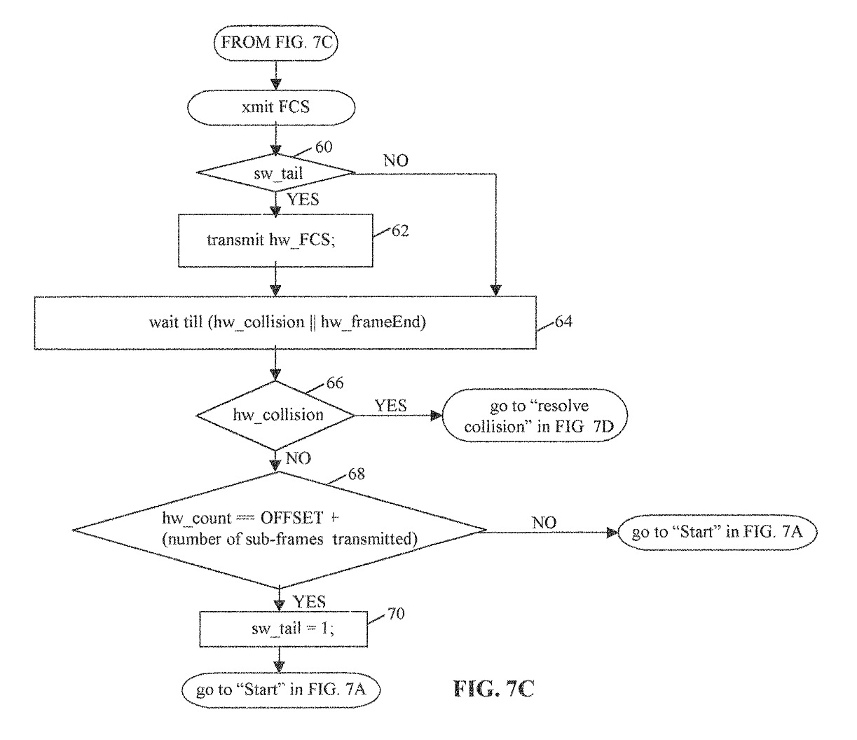

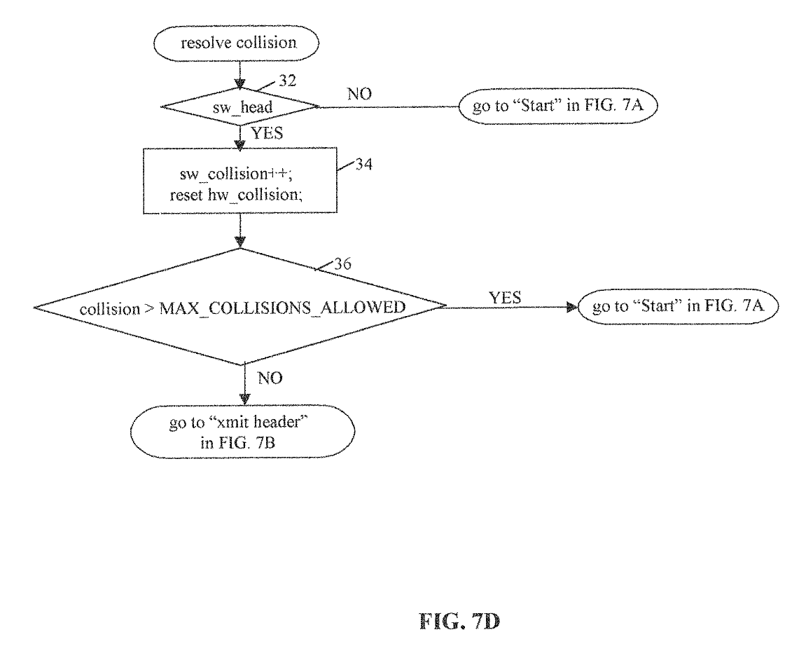

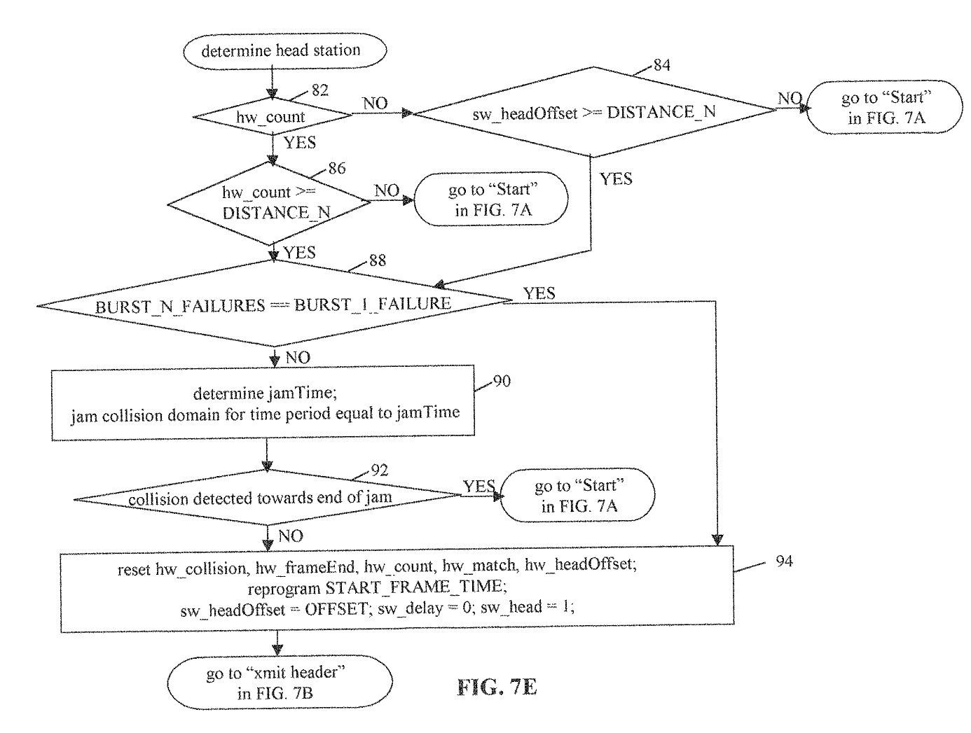

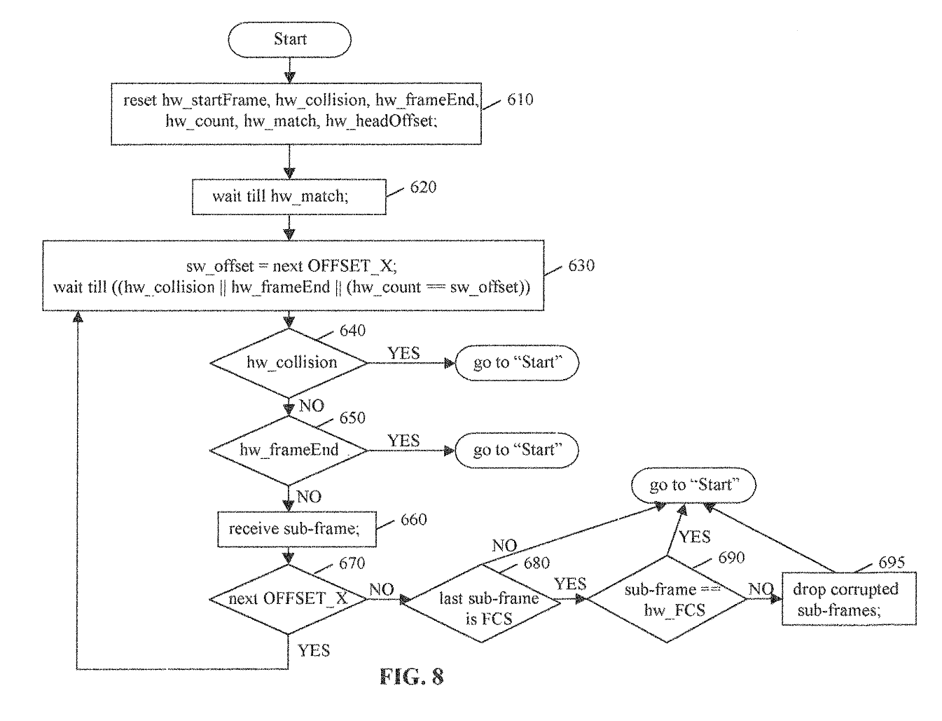

FIGS. 7 and 8—One Implementation of Operation of Station for Group Reception and Fault-Tolerant Group Transmission of Frame in Network

One implementation of operation of a station for group reception and fault-tolerant group transmission of frame in network is described with the use of flowcharts of FIGS. 7A through 7E and FIG. 8. The station has the following hardware registers; these registers exist in the QoS Multimedia Ethernet Interface 830 of FIG. 2:

hw_match. This register is SET when certain bits in the beginning of the frame in the network match those programmed. The processor RESETS this register. As an example, this register is SET when the multicast address in the destination field of FH in the network matches the multicast address that this interface is programmed with.

hw_startFrame: This register is SET when START_FRAME_TIME expires periodically. The processor RESETS this register. As an example, this register is SET every 10 ms when START_FRAME_TIME expires so compressed voice can be transmitted.

hw_frameEnd: This register is SET when the matched frame ends. The processor RESETS this register. As an example, this register is SET after the frame in the network has been matched AND the interface detects a gap greater than the IFG.

hw_headOffset: Loads the value of head_offset field when hw_match changes from RESET to SET.

hw_count. This register loads the value of head_offset field when hw_match changes from RESET to SET. It then starts incrementing for each byte (or any other unit of information) in the network after the head_offset field. Stops counting when frame ends. The processor RESETS this register.

hw_collision: This register is SET when collision is detected between start and end of matched frame. The processor RESETS this register.

hw_FCS: This register calculates FCS of the matched frame. It RESETS automatically at the end of frame.

The station has the following software registers; these registers exist in the processor cache 800 or memory 810 of FIG. 2:

START_FRAME_TIME: A constant time period that expires periodically. As an example, a clock can be used to determine this time periodically. This station use this periodic time only if it is at a distance of up to “n” stations from the head station.

OFFSET: A constant number of bytes (or any other unit of information). This station transmits sub-frames when the byte count past the head_offset field is equal to OFFSET.

Burst_{—}1_FAILURE/DISTANCE_{—}1. A constant number that has the OFFSET of previous station at a distance of 1 in the order of transmission. If the head station comes before the previous station, then the OFFSET of head station is used.

BURST_{—}2_FAILURES/DISTANCE_{—}2: A constant number that has the OFFSET of 2^{nd} previous station at a distance of 2 in the order of transmission. If the head station comes before the 2^{nd} previous station, then the OFFSET of head station is used.

BURST_N_FAILURES/DISTANCE_N: A constant number that has the OFFSET of n^{th} previous station at a distance of “n” in the order of transmission. If the head station comes before the n^{th} previous station, then the OFFSET of head station is used.

PROP_DELAY_PREV_{—}1: A constant number that has the propagation delay between this station and the previous station at a distance of 1 in the order of transmission. If the head station comes before the previous station, then the propagation delay between this station and the head station is used.

PROP_DELAY_PREV_{—}2: A constant number that has the propagation delay between this station and the 2^{nd} previous station at a distance of 2 in the order of transmission. If the head station comes before the 2^{nd} previous station, then the propagation delay between this station and the head station is used.

PROP_DELAY_PREV_N: A constant number that has the propagation delay between this station and the n^{th} previous station at a distance of “n” in the order of transmission. If the head station comes before the n^{th} previous station, then the propagation delay between this station and the head station is used.

PROP_DELAY_NEXT_{—}1: A constant number that has the propagation delay between this station and the next station at a distance of 1 in the order of transmission. If the tail station comes before the next station, then the propagation delay between this station and the tail station is used.

PROP_DELAY_NEXT_{—}2: A constant number that has the propagation delay between this station and the 2^{nd} next station at a distance of 2 in order of transmission. If the tail station comes before the 2^{nd} next station, then the propagation delay between this station aid the tail station is used.

PROP_DELAY_NEXT_N: A constant number that has the propagation delay between this station and the n^{th} next station at a distance of “n” in the order of transmission. If the tail station comes before the n^{th} next station, then the propagation delay between this station and the tail station is used.

MAX_COLLISIONS_ALLOWED: A constant number that provides an upper limit on the number of collisions that can happen in transmitting a frame by this head station. The head station terminates transmission of the current frame if this upper limit is crossed.

sw_head: This register contains Boolean 1 if this station is the head of its group, otherwise it contains a Boolean 0. It is initially programmed based on whether this station is the head or not. The value of this register changes when stations leave (i.e. become non-operational due to failure, removed from network, etc.) or join (i.e. become operational when connected to the network, etc.) their group.

sw_tail: This register contains Boolean 1 if this station is the tail of its group, otherwise it contains a Boolean 0. It is initially programmed based on whether this station is the tail or not. The value of this register changes when stations leave or join their group.

sw_delay: This register is programmed with a value that is equivalent to the maximum allowable time it takes the head station to start transmitting in the network after hw_startFrame is SET, plus the propagation delay from the head station to this station (PROP_DELAY_PREV_N) in the network. If clocks are used to determine when START_FRAME_TIME expires then the maximum allowable jitter among clocks of stations in this group should also be added to determine the programmed value of the delay. It is initially programmed based on the distance between this station and the head station. If this station is the head station, a value of 0 is loaded in this register, so it does not have a delay after START_FRAME_TIME expires.

sw_headOffset: This register contains the value of the head_offset field of the matched frame. It is initially programmed with the OFFSET of the head station in this group.

sw_collision: This register contains the number of collisions that happened in transmitting a frame. The head station uses this value to determine when to terminate transmission of the current frame.

FIGS. 7A through 7E are a flowchart illustrating one implementation of operation of station for fault-tolerant group transmission of Ethernet frame on collision domain. In step 10 of FIG. 7A the processor resets hardware registers and clears sw_collision. In step 12 the processor waits until either hw_match is set, OR, hw_startFrame is set AND this station is at a distance of up to “n” station from the head station. Note that sw_headOffset is initially programmed with the OFFSET of the head station in this group. If the head station fails, all stations at a distance of up to “n” stations will participate in recovery from this failure. In step 14 if hw_match is set, the processor proceeds to step 16; otherwise it proceeds to step 40. In step 16 the processor checks if the head_offset of the current matched frame in hw_headOffset is the same as that of the previous matched frame in sw_headOffset. If the two are same, the head station has not changed and the processor proceeds to step 50 in FIG. 7B; otherwise a new head station has started this frame, and the processor proceeds to step 18. In step 18, the processor loads the offset of the new head station from hw_headOffset to sw_headOffset. In step 20 if this station is at a distance of up to “n” stations from the head station, the processor proceeds to step 22; otherwise it proceeds to step 50 in FIG. 7B. In step 22 the processor reprograms sw_delay. To calculate the propagation delay, used to calculate the new sw_delay, the distance between this station and head station is determined by matching the head station offset in hw_headOffset with DISTANCE_N, and then picking the appropriate PROP_DELAY_PREV_N based on the distance. The processor then proceeds to step 50 in FIG. 7B.

If the processor proceeds to step 40 it waits for the current frame on the collision domain to end. The processor then waits until hw_match is set or a delay equivalent to sw_delay has expired. Note that if this is the head station then the value in sw_delay is 0, and the processor will proceed to step 42 without waiting. In step 42 if hw_match is set, the processor proceeds to step 16 and eventually to step 50 in FIG. 7B; otherwise is proceeds to step 44 in FIG. 7B.

The processor reaches step 44 if it is the head station and it is time to start a frame, or the head station failed and it is time to determine the new head station and start a frame. In step 44 if sw_head is set then this is the head station and the processor proceeds to step 46; otherwise it proceeds to step 82 in FIG. 7E to determine the new head station due to the failure of the current head station. In step 46 the processor transmits on the collision domain the FH, followed by its OFFSET in the head_offset field of the frame. It then proceeds to step 50.

If the processor proceeds to step 82 in FIG. 7E to determine the new head station the hw_count will be 0 because the frame was not transmitted due to the failure of the current head station, and the processor proceeds to step 84. In step 84 if this station is at a distance of up to “n” stations from the head station detected to have failed, then this station can participate in the determination of the head station and the processor proceeds to step 88; otherwise it proceeds to step 10 in FIG. 7A. In step 88 if this group of stations is configured to recover only from a burst of single failure then this station is at a distance of 1 from the head station detected to have failed. This station is the only participant involved in recovery from this failure, so the processor proceeds to step 94; otherwise it proceeds to step 90 to determine the closest operational station from the first failed station, which is the head station. In step 90 the processor determines the time period (jamTime) for jamming the collision domain. The components of the jamTime equation are determined as follows:

(1) The value of “n” is known based on the burst of station failures that this group of stations is configured to recover from.

(2) The value of “distance” between this station and head station is known by matching the head station offset in sw_headOffset with DISTANCE_N.

(3) The propagation delay is determined by picking the appropriate PROP_DELAY_NEXT_N with a forward distance of (n−distance) between this station and station with maximum distance.

The processor then jams the collision domain for a time period equal to jamTime. In step 92 if the processor detects collision towards the end of the jam period, then it is not the new head station and it proceeds to step 10 in FIG. 7A; otherwise, it is the new head station and it proceeds to step 94. In step 94, the hardware registers are reset, the START_FRAME_TIME is reprogrammed, sw_head is set to identify this station as the new head, sw_delay is 0, and sw_headOffset is loaded with OFFSET. The processor then proceeds to step 46 in FIG. 7B, where it transmits on the collision domain the FH and OFFSET of the frame. It then proceeds to step 50.

In step 50 the processor waits to transmit its sub-frames. While waiting, the processor checks for any one of the following conditions to occur: collision has occurred in the collision domain, OR the frame has ended prematurely, OR it is its turn to transmit its sub-frames. If the condition is met, the processor proceeds to step 52. In step 52 if collision has occurred the processor proceed to step 32 in FIG. 7D; otherwise it proceeds to step 54. In step 32 the processor proceeds to step 34 if this station is the head station; otherwise it proceeds to step 10 in FIG. 7A. In step 34 the processor increments sw_collision, rests hw_collision, and proceeds to step 36. In step 36 if the number of collisions occurred so far in transmitting this frame exceed the maximum allowed then the processor terminates transmission of this frame by proceeding to step 10 in FIG. 7A; otherwise it proceeds to step 46 in FIG. 7B where it proceeds to transmit the frame again.

In step 54 of FIG. 7B if the frame ends prematurely the processor proceeds to step 82 in FIG. 7E; otherwise it proceeds to step 56. In step 82 of FIG. 7E the processor proceeds to step 84 if the head station failed, so hw_count has a value of 0; otherwise it proceeds to step 86. In step 86 if this station is at a distance of up to “n” stations from the station detected to have failed, then this station can participate in the determination of the head station and the processor proceeds to step 88; otherwise it proceeds to step 10 in FIG. 7A. The hw_count in step 86 contains the OFFSET of the first (in the order and direction of transmission) station detected to have failed. The rest of the steps to determine the head station were explained previously, so they will not be explained again.

In step 56 of FIG. 7B the amount of bytes transmitted in this frame on the collision domain is equal to the OFFSET of this station, so this station transmits its sub-frames and proceeds to step 60 of FIG. 7C. In step 60 if this station is the tail of this group then it proceeds to step 62; otherwise it proceeds to step 64. In step 62 this tail station transmit FCS from hw_FCS, and proceeds to step 64. In step 64 the processor checks for any one of the following conditions to occur: collision has occurred in the collision domain, OR the frame has ended. If the condition is met, the processor proceeds to step 66. In step 66 if collision has occurred the processor proceeds to step 32 in FIG. 7D; otherwise the frame has ended and it proceeds to step 68. Step 32 of FIG. 7D leads to resolving the collision, this has been explained previously, so it will not be explained again. In step 68 of FIG. 7C if this station was the last to transmit its sub-frames then the processor proceeds to step 70; otherwise it proceeds to step 10 in FIG. 7A. In step 70 sw_tail is set to identify this station as the tail station of this group, and the processor proceeds to step 10 in FIG. 7A.

FIG. 8 is a flowchart illustrating one implementation of operation of station for group reception of sub-frames from Ethernet frame on collision domain. The station has a list of one or more offsets. OFFSETS_X, into the matched frame at which the sub-frames and FCS are retrieved. The following additional software registers are needed for the receive operation:

OFFSET_{—}1: A constant of bytes (or any other unit of information) to retrieve the first sub-frame or FCS. The station picks the following sub-frame/FCS from the matched frame when the byte count past the head_offset field is equal to this offset.

OFFSET_{—}2: A constant number of bytes (or any other unit of information) to retrieve the second sub-frame. The station picks the following sub-frame/FCS from the matched frame when the byte count past the head_offset field is equal to this offset. p1 OFFSET_X: A constant number of bytes (or any other unit of information) to retrieve the x^{th} sub-frame. The station picks the following sub-frame/FCS from the matched frame when the byte count past the head_offset field is equal to this offset

sw_offset: This register contains the value of the offset in bytes (or any other unit of information) of the matched frame at which the sub-frame will be retrieved.

In step 610 the processor resets hardware registers. In step 620 the processor waits until hw_match is set. In step 630 the processor loads sw_offset with the next offset at which the sub-frame will be retrieved. It then waits until one of the following conditions occur: collision has occurred in the collision domain, OR the frame has ended prematurely, OR it is its turn to receive its sub-frame. If the condition is met, the processor proceeds to step 640. In step 640 if collision has occurred the processor proceeds to step 610, otherwise it proceeds to step 650. In step 650 if the frame ends prematurely the processor proceed to step 610; otherwise it proceeds to step 660. In step 660 the amount of bytes counted in hw_count is equal to the offset in sw_offset, so the next sub-frame is retrieved from the collision domain, and the processor proceeds to step 670. In step 670 if there is another offset at which another sub-frame has to be retrieved then the processor proceeds to step 630; otherwise it proceeds to step 680. In step 680 if the last sub-frame received is the FCS then the processor proceeds to step 690; otherwise it proceeds to step 610. In step 690 if the FCS received is the same as hw_FCS then the processor proceeds to step 610; otherwise the sub-frames received from this frame have been corrupted, and the processor drops the sub-frames in step 695 before proceeding to step 610.

Although the descriptions above contain much specificity, these should not be construed as limiting the scope of the invention but as merely providing illustrations of some of the presently preferred embodiments of this invention. Thus the scope of the invention should be determined by the appended claims and their legal equivalents, rather than by the examples and implementations provided.

For example, even though this invention is described with the use of a wired collision domain operating at 10 Mb/s, it applies equally to a wireless collision domain or to a combination of both wired and wireless collision domain operating at all possible speeds (10 Mb/s, 100 Mb/s, 1000 Mb/s, etc.). Also, the use of the term collision domain includes shared networks and buses consisting of wired, wireless, or a combination of both wired and wireless communication channels operating at all possible speeds. Also, the conceptual shape of the collision domain can be in any form (e.g. ring) as long as each station in the group of transmitter stations has at least one neighbor station.

The implementations described so far show that stations can transmit and receive multiple sub-frames of different sizes.

I claim:

1. A method for forming group of transmitter stations in a network so stations in the group collectively transmit a frame of data, said network including a plurality of stations including said group of transmitter stations, a communication medium between neighbor stations, said method comprising:
having less than a predetermined maximum round-trip propagation delay on the communication medium between neighbor stations in said group of transmitter stations, in said network.

2. The method of claim 1 wherein said network is a collision domain.

3. The method of claim 1 wherein said network is wireless.

4. A method for a group of transmitter stations to transmit a frame of data in a network, said network including a plurality of stations including said group of transmitter stations, said method comprising:
means for order of transmission of stations in said group of transmitter stations so head station starts transmission of said frame and other stations transmit data in said frame in said order of transmission;
head station in said group of transmitter stations starts transmitting data in said frame;
frame identification means for station in said group of transmitter stations to identify said frame in said network in which to transmit;
data counting means for station in said group of transmitter stations to determine when to transmit data in said frame in said network; and
data transmission means for station in said group of transmitter stations to transmit data such that data transmitted are perceived as part of said frame by said plurality of stations in said network.

5. The method of claim 4 wherein said network is a collision domain.

6. The method of claim 4 wherein said network is wireless.

7. The method of claim 4 wherein said head station transmits Frame Header in said frame.

8. The method of claim 4 wherein said group of transmitter stations changes dynamically.

9. The method of claim 4 further comprising:
station in said group of transmitter stations to transmit data as it becomes available instead of assembling all data before transmission.

10. The method of claim 4 wherein said frame identification means includes a unique destination multicast address in the header to identify said frame in said network in which to transmit.

11. A method for a group of receiver stations to receive data from a frame in a network, said network including a plurality of stations including said group of receiver stations, said method comprising:
frame identification means for station in said group of receiver stations to identify said frame in said network in which to receive, and
data counting means for station in said group of receiver stations to determine when to retrieve data in said frame in said network.

12. The method of claim 11 wherein said network is wireless.

13. The method of claim 11 wherein said group of receiver stations change dynamically.

14. The method of claim 11 wherein said data is sub-frames.

15. The method of claim 14 wherein sub-frames are variable in size.

16. A method or fault tolerance from bursts of failures in a group of transmitter stations that transmit a frame in a network, said network including a plurality of stations including said group of transmitter stations, said group of transmitter stations including failed and operating stations, said group of transmitter stations transmit in a predetermined order, said method comprising:
failure detection means for operating stations in said group of transmitter stations to determine failure of station in said group of transmitter stations;
means for determining the operating station that is next to transmit after the burst of failed stations in said group of transmitter stations;
group forming means for forming another group of transmitter stations from said group of transmitter stations; and
means for said another group of transmitter stations to transmit a frame in said network.

17. The method of claim 16 wherein said network is a collision domain.

18. The method of claim 16 wherein said network is wireless.
